(19) United States
(12) Patent Application Publication
(10) Pub. No.: US 2012/0225331 A1
(43) Pub. Date: Sep. 6, 2012

(54) BATTERY PACK PROTECTION SYSTEM

(75) Inventor: Steven Tartaglia, Safety Harbor, FL (US)

(73) Assignee: LITHIONICS, LLC, Safety Harbor, FL (US)

(21) Appl. No.: 13/038,976

(22) Filed: Mar. 2, 2011

(51) Int. Cl. H01M 2/10; H01M 10/42; H01M 2/02

(52) U.S. Cl. 429/50; 429/159

(57) ABSTRACT

An application for a battery pack that includes walls made of sturdy material, power interface terminals and battery cells/electronics held within the walls. A protective layer contains the battery cells. The protective layer reduces external harm from heat, out-gassing and/or explosion of one or more of the battery cells.

### CROSS-REFERENCE TO RELATED APPLICATION

This is related to patent application titled “BATTERY CUSHION AND INSULATOR,” Ser. No. 12/786,473, attorney docket 3037.0, inventor Steven Tartaglia, filed May 25, 2010 and patent application titled “BATTERY PACK THERMAL PROTECTION FROM HEAT STERILIZATION,” Ser. No. 12/789,597, attorney docket 3044.0.

### FIELD

This invention relates to the field of batteries and more particularly to a system for reducing damage from battery cells that burst, ignite and/or explode.

### BACKGROUND

Battery cells such as flooded lead-acid, absorbed-glass-matt (AGM), lead-acid, Nickel Cadmium (NiCd), Nickel Metal Hydride (NiMh) and the like perform best at certain temperature ranges and are easily damaged when shorted or exposed to very high temperatures. When such battery cells are exposed to certain high temperatures or are quickly discharged, various physical changes occur internal to the battery cells such as boiling of the electrolyte, etc. In an extreme case, such as boiling of the electrolyte, high pressure results within the sealed cell, leading to possible deformation of the outer case, deformation of the anode/cathode arrangements and, possible out-gassing or leakage of electrolyte, and possibly bursting or explosion.

Newer, ecology minded technologies such as lithium ion (Li-ion) and Lithium Ion (Li Fe) normally provide enhanced use/charge cycles over prior technologies such as nickel cadmium, but are even more susceptible to issues related to high temperatures and fast discharge. In, for example, Lithium Ion battery cells, the thin Solid Electrolyte Interface (SEI) layer on the anode breaks down due to overheating caused by excessive currents, overcharging or high temperatures. The breakdown of the SEI layer starts to occur at the relatively low temperature of 80° C. Once the SEI layer is breached, the electrolyte reacts with the carbon anode at a higher, uncontrolled, temperature, creating an exothermal reaction which drives the temperature up still further. Therefore, it is important to assure that the core temperature of Lithium Ion cells remains well under 80° C., preferably under 75° C. and that the cells are not subject to over discharge rates such as shorting the anode to the cathode.

There have been several instances in which it is possible or suspected that certain battery chemistries being shorted during transit ignited fires that resulted in extensive damage to, for example, a cargo plane. It has been speculated that Lithium Ion Personal Computer Batteries led to a fire on United Parcel Services Flight 1307, in Philadelphia, September of 2006.

As one example, Lithium Ion batteries have very high energy densities. When Lithium Ion batteries are overheated or overcharged, the potential exists for thermal runaway and cell rupture, in extreme cases leading to combustion. A deep discharge of the cells often creates a short-circuit within the cell, after which, recharging would be unsafe. To reduce these risks, Lithium-ion battery packs some times contain circuitry that controls charge and discharge of the battery cells but such circuitry itself is subject to failure. In addition, when Lithium-ion battery packs are stored for long periods of time, the power drain of this circuitry will drains the battery cells below the minimum specified voltage for the cells. When a battery pack is inadvertently subject to high current draw, such as when the battery pack terminals are shorted during transportation, excessive current is capable of damaging the protection circuit, thereby enabling the battery pack to begin an exothermal reaction, possibly causing a fire within the carrier (e.g. airplane) that is further fed by other near-by battery packs.

The individual cells are often required to have shut-down separators for over-temperature, tear-away tabs for internal pressures, pressure relief vents and thermal interrupt to prevent excessive current draw and to prevent overcharging. These circuits along with improved electrode designs reduce the risk of fire or explosion, but there still exists the potential of fire and/or explosion when such battery cells/packs are misused or exposed to unexpected events such as excessive heat, puncture, etc.

The United Nations Department of Transportation (U.N.D.O.T.) Manual of Tests and Criteria, section 38.3 specifies various tests required to be passed in order to obtain U.N.D.O.T approval for transportation of Lithium based batteries.

What is needed is a battery pack that reduces or eliminates the impact of a failure of one or more battery cells in a battery pack.

### SUMMARY

A battery pack is disclosed including a set of walls made of sturdy material, power interface terminals and battery cells/electronics held within the walls and within a protective layer. The protective layer reduces external harm from heat, out-gassing and/or explosion of one or more of the battery cells.

In one embodiment, a battery pack is disclosed including an enclosure with one or more battery cells held within the enclosure. A protective layer is situated within the enclosure and encapsulates the battery cells. Connection terminals mounted on the enclosure are electrically accessible from outside of the enclosure and conduct electricity through the enclosure. Two or more conductors electrically connect a contact of the connection terminal with a terminal of one or more of the battery cells. The protective layer contains excess heat and forces created when one or more of the battery cells overheat, vent or explode.

In another embodiment, a method of reducing damage resulting from battery cell failure is disclosed including providing one or more battery cells. The battery cells are surrounded in surrounding the battery cells in a protective layer and are electrically interfaced to connection terminals by a plurality of interconnecting conductive paths that pass through the protective layer. The battery cells and the protective layer are capsulated in an enclosure, the connection terminals pass through the enclosure, thereby providing power accessible from outside of the enclosure. The protective layer reduces external harm from heat, out-gassing and/or explosion of one or more of the battery cells.

In another embodiment, a battery pack is disclosed including an enclosure that holds two or more battery cells. Conductive paths interconnect battery terminals of the battery cells in series, parallel or series-parallel configurations. A protective layer is disposed within the enclosure and encapsulates the battery cells. Connection terminals that are electrically accessible from outside of the enclosure conduct electricity from the battery cells within the enclosure. Two or more conductors conduct electricity between contacts of the connection terminal with terminals of one or more of the battery cells or connect the terminals of one or more of the battery cells with other terminals of one or more of the battery cells. A dampening layer is disposed between the protective layer and the enclosure. The protective layer contains excess heat and forces created when one or more of the battery cells overheat, vent or explode and the dampening layer reduces vibration and rattle of the battery cells within the enclosure.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a perspective view of a typical battery pack of the prior art.

FIG. 2 illustrates a perspective view of a battery pack with a protective layer surrounding battery cells.

FIG. 3 illustrates a plan view of battery cells with the protective layer.

FIG. 4 illustrates a cross-sectional view of a battery pack with the protective layer.

FIG. 5 illustrates a cross-sectional view of a battery pack with the protective layer and a foam vibration dampening layer.

FIG. 6 illustrates a cross-sectional view of another battery pack with the protective layer, a vibration dampening layer and electrical insulation layer.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

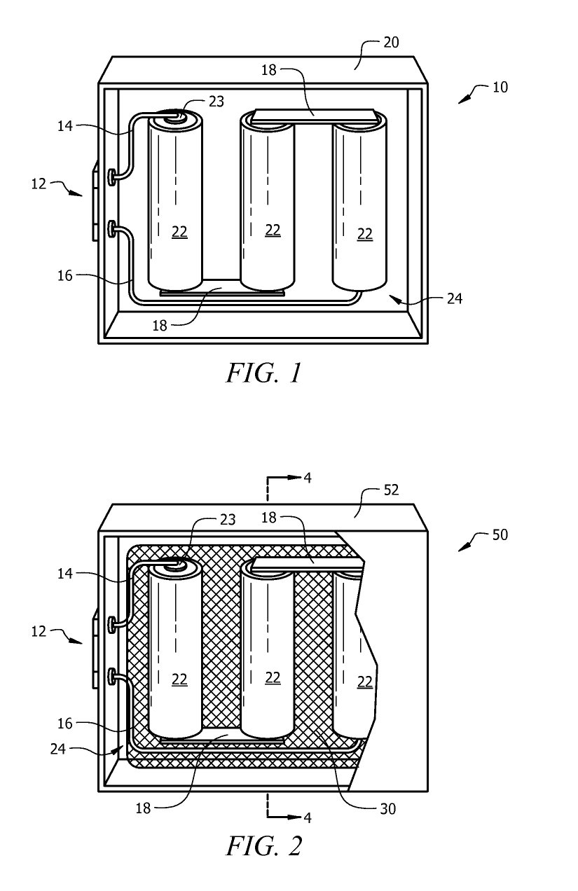

Referring to FIG. 1, a perspective view of a typical battery pack 10 of the prior art will be described. Typical battery packs 10 have a plastic enclosure 20, usually made of Acrylonitrile butadiene styrene otherwise known as ABS. Within the plastic enclosure 20 are one or more battery cells 22 connected in series, parallel or series/parallel by interconnecting conductive paths 18, typically flat metal sheets that are tack-welded to battery terminals. One or more battery terminals 23 are connected to a power connection terminal 12 by wires 14/16 or other conductive paths for the delivery of power to a device and for the charging of the battery cells 22.

Although not shown, for completeness, often such battery packs 10 include other devices such as electronic circuits that prevent over current, over voltage, under voltage, control charging, prevent over-temperature situations during charging, etc. All such devices are known and present in some battery packs, but have been left out for clarity reasons.

Although the size of the plastic enclosure 20 is shown exaggeratedly larger than needed, it is known that inside surfaces of such cases 20 often directly touch the battery cells 22 to support the battery cells 22. It is also known that an air gap 24 separates the battery cells 22 from the inside surface of the plastic enclosure 20 in places where no contact is made.

When such a battery pack 10 subjected to adverse conditions due to excess heat, internal failure, shorted contacts, etc., one or more individual cells 22 potentially will react. In some situations, the cells 22 will heat, potentially deforming the case 20. In more severe situations, pressure will build up within the battery cells 22 and the battery cells 22 will heat, deform and, in some situations, out-gas. Out-gassing occurs when the electrolyte boils and changes state from a liquid to a gas, in which increases in pressure force open a safety valve, allowing the gas to escape. In still more severe situations, the pressure and heat build-up within the battery cells 22 causes the battery cells 22 to burst and/or explode.

Being encapsulated in a plastic case 20 provides little resistance to any heat, pressure or explosion of the individual battery cells 22. The typical ABS material quickly weakens under heat and pressure and provides little or no containment of any heat, excess gas pressure or explosion from one or more of the individual battery cells 22.

Referring to FIG. 2, a view of a battery pack 10 with a protective layer 30 surrounding the battery cells 22 will be described. The battery pack 50 has an enclosure 52, made of any sturdy material such as ABS, preferably a heat resistant material such as Ultem from GE plastics. Within the enclosure 52 are one or more battery cells 22 connected in series, parallel or series/parallel by interconnecting conductive paths 18, typically flat metal sheets that are tack-welded to battery terminals. Any known or future battery chemistry is anticipated including, but not limited to, alkaline, lead acid, nickel cadmium, nickel metal hydride, lithium, lithium ion, mercury, lithium iron, etc.

One or more battery terminals 23 are connected to a power connection terminal 12 by wires 14/16 or other conductive paths for the delivery of power to a device and for the charging of the battery cells 22.

The battery cells 22 are enclosed in protective layer 30 made from a woven, thermally protective material. The protective layer 30 substantially or entirely surrounds the battery cells 22, containing some or all excess heat or explosive force while permitting gases to escape.

The protective material 30 is preferably a fabric substrate with a polymer coating. Various coatings are known such as Silicone, PTFE, Urethane, Neoprene, Fluroelastomers and many others. One example is Flouroelastomer Coated Glass Fabric that operates in temperature extremes of up to 500 degrees F. and has excellent chemical and water resistance. Such materials are known for use in welding and other uses, but not for use in battery packs 50.

Another exemplary material for use as the protective layer 30 is a high performance textile that is comprised of high purity, high strength amorphous silica fibers. Such Silica Textiles are designed for use where severe temperature conditions exist. The amorphous silica fibers are unaffected by most chemicals. Such materials are known for use in thermal insulation systems designed for severe temperatures, such as turbine covers, exhaust silencer covers, etc, but not for use in battery packs 50. These materials are rated for temperatures as high as 1800 degrees F.

In some embodiments, there is an air gap 24 between the protective layer 30 and the enclosure 52, although in some embodiments, the air gap 24 is displaced by a dampening material 32 (see FIG. 5).

Although not shown, for completeness, often such battery packs 50 include other devices such as electronic circuits that prevent over current, over voltage, under voltage, control charging, prevent over-temperature situations during charging, etc. All such devices are known and present in some battery packs, but have been left out for clarity reasons.

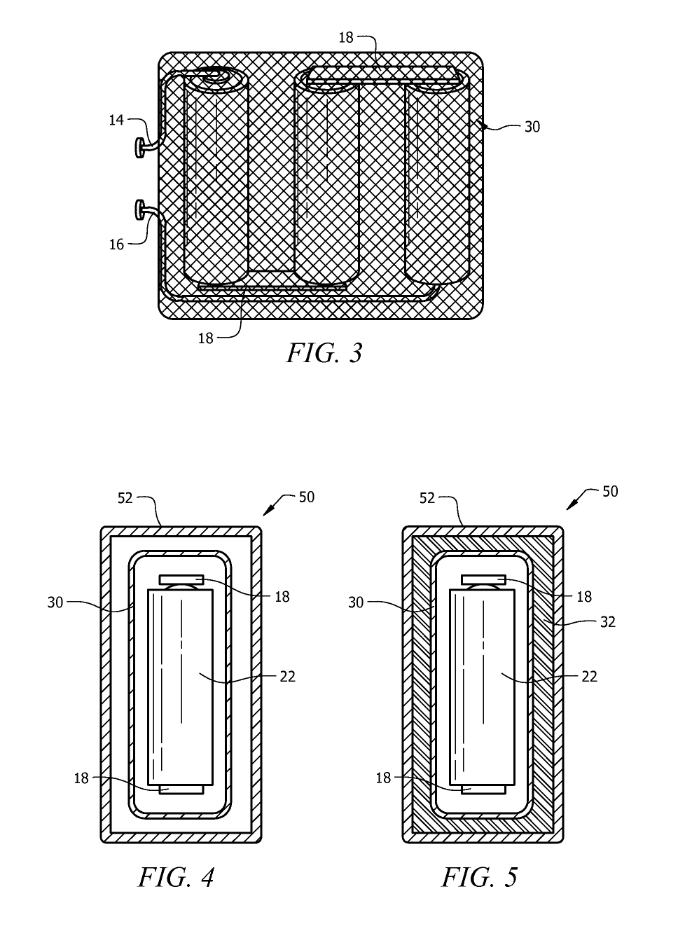

Referring to FIG. 3, a plan view of battery cells 22 with the protective layer 30 will be described. The one or more battery cells 22 connected in series, parallel or series/parallel by interconnecting conductive paths 18, typically flat metal sheets that are tack-welded to battery terminals. Any known or future battery chemistry is anticipated including, but not limited to, alkaline, lead acid, nickel cadmium, nickel metal hydride, lithium, lithium ion, mercury, lithium iron, etc.

Two or more of the batteries are connected to wires 14/16 or other conductive paths for the delivery of power to a device (external to the battery pack 52) and for the charging of the battery cells 22 (e.g. from an external charger).

The battery cells 22 are enclosed in protective layer 30 made from a woven, thermally protective material. The protective layer 30 substantially or entirely surrounds the battery cells 22, containing some or all excess heat or explosive force while permitting gases to escape. In some embodiments, the protective layer 30 is provided as a fabric pouch into which the battery cells 22 are inserted and the pouch is closed, allowing the wires 14/16 to extend beyond the protective layer 30 for connection to, for example, a connector 12 (see FIG. 1).

The protective material 30 is preferably a fabric substrate with a polymer coating. Various coatings are known such as Silicone, PTFE, Urethane, Neoprene, Fluroelastomers and many others. One example is Flouroelastomer Coated Glass Fabric that operates in temperature extremes of up to 500 degrees F. and has excellent chemical and water resistance. Such materials are known for use in welding and other uses, but not for use in battery packs 50.

Another exemplary material for use as the protective layer 30 is a high performance textile that is comprised of high purity, high strength amorphous silica fibers. Such Silica Textiles are designed for use where severe temperature conditions exist. The amorphous silica fibers are unaffected by most chemicals. Such materials are known for use in thermal insulation systems designed for severe temperatures, such as turbine covers, exhaust silencer covers, etc, but not for use in battery packs 50. These materials are rated for temperatures as high as 1800 degrees F.

Although not shown, for completeness, often such battery packs 50 include other devices such as electronic circuits that prevent over current, over voltage, under voltage, control charging, prevent over-temperature situations during charging, etc. All such devices are known and present in some battery packs, but have been left out for clarity reasons.

When present, such other devices are preferably located within the protective layer 30, although it is anticipated that these devices are alternately located between the enclosure 52 and the protective layer 30.

Referring to FIG. 4, a simplified cross-sectional view of a battery pack 50 with the protective layer 30 will be described. The one or more battery cells 22 connected in series, parallel or series/parallel by interconnecting conductive paths 18, typically flat metal sheets that are tack-welded to battery terminals. Again, any known or future battery chemistry is anticipated including, but not limited to, alkaline, lead acid, nickel cadmium, nickel metal hydride, lithium, lithium ion, mercury, lithium iron, etc. The connecting wires 14/16 are not shown for clarity purposes.

The battery cells 22 are enclosed in protective layer 30 made from a woven, thermally protective material. The protective layer 30 substantially or entirely surrounds the battery cells 22, containing some or all excess heat or explosive force while permitting gases to escape. The battery cells 22 and protective layer 30 are encapsulated by a rigid enclosure 20 as known in the industry.

The protective material 30 is preferably a fabric substrate with a polymer coating. Various coatings are known such as Silicone, PTFE, Urethane, Neoprene, Fluroelastomers and many others. One example is Flouroelastomer Coated Glass Fabric that operates in temperature extremes of up to 500 degrees F. and has excellent chemical and water resistance. Such materials are known for use in welding and other uses, but not for use in battery packs 50.

Another exemplary material for use as the protective layer 30 is a high performance textile that is comprised of high purity, high strength amorphous silica fibers. Such Silica Textiles are designed for use where severe temperature conditions exist. The amorphous silica fibers are unaffected by most chemicals. Such materials are known for use in thermal insulation systems designed for severe temperatures, such as turbine covers, exhaust silencer covers, etc, but not for use in battery packs 50. These materials are rated for temperatures as high as 1800 degrees F.

Although not shown, for completeness, often such battery packs 50 include other devices such as electronic circuits that prevent over current, over voltage, under voltage, control charging, prevent over-temperature situations during charging, etc. All such devices are known and present in some battery packs, but have been left out for clarity reasons. When present, such other devices are preferably located within the protective layer 30, although it is anticipated that these devices are alternately located between the enclosure 52 and the protective layer 30.

In this embodiment, an air gap is present between the protective layer 30 and the enclosure 52. In such embodiments, the size of the air gap is minimized to reduce vibration and rattle from the battery cells 22.

Referring to FIG. 5, a cross-sectional view of a battery pack 50 with the protective layer 30 and a vibration dampening layer 32 will be described. As previously described, the one or more battery cells 22 connected in series, parallel or series/parallel by interconnecting conductive paths 18, typically flat metal sheets that are tack-welded to battery terminals. Again, any known or future battery chemistry is anticipated including, but not limited to, alkaline, lead acid, nickel cadmium, nickel metal hydride, lithium, lithium ion, mercury, lithium iron, etc. The connecting wires 14/16 are not shown for clarity purposes.

The battery cells 22 are enclosed in protective layer 30 made from a woven, thermally protective material. The protective layer 30 substantially or entirely surrounds the battery cells 22, containing some or all excess heat or explosive force while permitting gases to escape. The battery cells 22 and protective layer 30 are encapsulated by a rigid enclosure 20 as known in the industry.

The protective material 30 is preferably a fabric substrate with a polymer coating. Various coatings are known such as Silicone, PTFE, Urethane, Neoprene, Fluroelastomers and many others. One example is Flouroelastomer Coated Glass Fabric that operates in temperature extremes of up to 500 degrees F. and has excellent chemical and water resistance. Such materials are known for use in welding and other uses, but not for use in battery packs 50.

Another exemplary material for use as the protective layer 30 is a high performance textile that is comprised of high purity, high strength amorphous silica fibers. Such Silica Textiles are designed for use where severe temperature conditions exist. The amorphous silica fibers are unaffected by most chemicals. Such materials are known for use in thermal insulation systems designed for severe temperatures, such as turbine covers, exhaust silencer covers, etc, but not for use in battery packs 50. These materials are rated for temperatures as high as 1800 degrees F.

Although not shown, for completeness, often such battery packs 50 include other devices such as electronic circuits that prevent over current, over voltage, under voltage, control charging, prevent over-temperature situations during charging, etc. All such devices are known and present in some battery packs, but have been left out for clarity reasons. When present, such other devices are preferably located within the protective layer 30, although it is anticipated that these devices are alternately located between the enclosure 52 and the protective layer 30.

In this embodiment, a vibration dampening layer 32 is provided between the enclosure and the protective layer 30. In such embodiments, the vibration dampening layer 32 reduces vibration and rattles from the battery cells 22. The vibration dampening layer 32 is made from any suitable material such as polyurethane foam, etc.

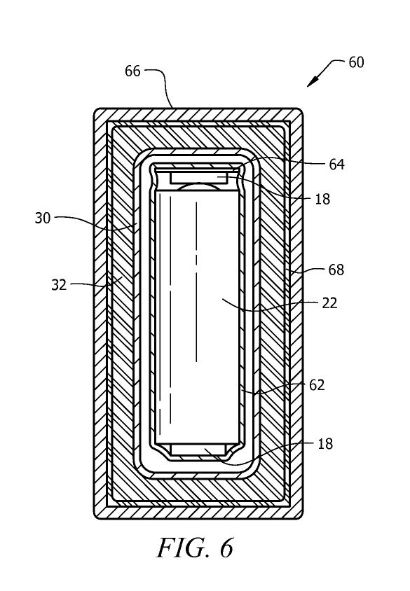

Referring to FIG. 6, a cross-sectional view of another battery pack 60 with the protective layer 30, a vibration dampening layer 32 and electrical insulation layer 62/64/68 will be described. As previously described, the one or more battery cells 22 connected in series, parallel or series/parallel by interconnecting conductive paths 18, typically flat metal sheets that are tack-welded to battery terminals. Again, any known or future battery chemistry is anticipated including, but not limited to, alkaline, lead acid, nickel cadmium, nickel metal hydride, lithium, lithium ion, mercury, lithium iron, etc. The connecting wires 14/16 are not shown for clarity purposes.

In this embodiment, the an insulative layer 64 made of, for example, a fire resistant paper or cardboard covers most or all of the battery terminals and interconnecting conductive paths 18 and the battery cells 22 are enclosed in a shrink-wrap film 62 such as polyolefin and then the entire assembly 22/18/62/64 is enclosed in a protective layer 30 made from a woven, thermally protective material. The protective layer 30 substantially or entirely surrounds the battery cells 22, containing some or all excess heat or explosive force while permitting gases to escape. The insulative layer 64 and/or the shrink-wrap film 62 electrically isolates the battery cells 22. In this embodiment, the enclosure 66 is made from stronger materials that, in some embodiments, conduct electricity which has the potential to conduct electricity from the battery cells 22, creating a potential for reduced battery life or overheating due to excessive current flowing. In this embodiment, although the enclosure 66 is anticipated to be made from any suitable, sturdy material (polyethylene, polypropylene, etc), the enclosure 66 is preferably made from a material that has improved strength, even though these materials often conduct electricity. One such material is a plastic with carbon fibers. These materials are known for improved structural strength.

In some embodiments, the enclosure is lined with a coating of an electrically insulative material 68 such as fiberglass to improve strength and provide additional insulation between the

As in the previous embodiments, the protective material 30 is preferably a fabric substrate with a polymer coating. Various coatings are known such as Silicone, PTFE, Urethane, Neoprene, Fluroelastomers and many others. One example is Flouroelastomer Coated Glass Fabric that operates in temperature extremes of up to 500 degrees F. and has excellent chemical and water resistance. Such materials are known for use in welding and other uses, but not for use in battery packs 50. Another exemplary material for use as the protective layer 30 is a high performance textile that is comprised of high purity, high strength amorphous silica fibers. Such Silica Textiles are designed for use where severe temperature conditions exist. The amorphous silica fibers are unaffected by most chemicals. Such materials are known for use in thermal insulation systems designed for severe temperatures, such as turbine covers, exhaust silencer covers, etc, but not for use in battery packs 50. These materials are rated for temperatures as high as 1800 degrees F.

Although not shown, for completeness, often such battery packs 50 include other devices such as electronic circuits that prevent over current, over voltage, under voltage, control charging, prevent over-temperature situations during charging, etc. All such devices are known and present in some battery packs, but have been left out for clarity reasons.

When present, such other devices are preferably located within the protective layer 30, although it is anticipated that these devices are alternately located between the enclosure 52 and the protective layer 30.

In this embodiment, a vibration dampening layer 32 is provided between the enclosure and the protective layer 30, although it is not required. In such embodiments, the vibration dampening layer 32 reduces vibration and rattles from the battery cells 22. The vibration dampening layer 32 is made from any suitable material such as polyurethane foam, etc.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A battery pack comprising:
an enclosure;
one or more battery cells held within the enclosure;
a protective layer disposed within the enclosure and encapsulating the battery cells;
a connection terminal electrically accessible from outside of the enclosure; and
two or more conductors, each conductor electrically connecting a contact of the connection terminal with a terminal of one or more of the battery cells;
whereas the protective layer contains excess heat and forces created when one or more of the battery cells overheat, vent or explode.

2. The battery pack of claim 1, wherein the one or more battery cells is two or more battery cells and the battery pack further comprises interconnecting conductive paths, each interconnecting conductive path connecting battery terminals of the batteries in series, parallel or series-parallel.

3. The battery pack of claim 1, wherein the protective layer is a high-temperature, woven cloth material.

4. The battery pack of claim 3, wherein the high temperature, woven cloth material is coated with a polymer.

5. The battery pack of claim 4, wherein the polymer is selected from the group consisting of silicone, PTFE, urethane, neoprene, and fluroelastomers.

6. The battery pack of claim 4, wherein the woven cloth material is a glass based fabric.

7. The battery pack of claim 1, further comprising a dampening layer, the dampening layer disposed between the enclosure and the protective layer.

8. The battery pack of claim 2, further comprising an electrical insulation layer, the electrical insulation layer covering the battery cells and the interconnecting conductive paths, the electrical insulation layer comprising one or more sheets of fire-retardant paper/cardboard covering at least the interconnecting conductive layers, the electrical insulation layer comprising a shrink-wrap layer covering the fire-retardant paper/cardboard, the interconnecting conductive layers and the battery cells.

9. The battery pack of claim 8, wherein the electrical insulation layer is polyolefin.

10. The battery pack of claim 1, wherein the enclosure is made of plastic.

11. The battery pack of claim 8, wherein the enclosure is made of carbon filed plastic.

12. The battery pack of claim 11, wherein an inside wall of the enclosure is coated with fiberglass.

13. A method of reducing battery cell failure during heat sterilization, the method comprising:
providing two or more battery cells;
surrounding the battery cells in a protective layer;
electrically connecting the battery cells to connection terminals by a plurality of interconnecting conductive paths, the interconnecting conductive paths passing through the protective layer; and
enclosing the battery cells and the protective layer in an enclosure, the enclosure having connection terminals, the connection terminals electrically interfaced to the battery cells by the conductive paths, thereby providing power accessible from outside of the enclosure;
whereas the protective layer reduces external harm from heat, out-gassing and/or explosion of one or more of the battery cells.

14. The method of claim 13, wherein the protective layer is a high-temperature, woven cloth material.

15. The method of claim 14, wherein the high temperature, woven cloth material is coated with a polymer.

16. The method of claim 15, wherein the polymer is selected from the group consisting of silicone, PTFE, urethane, neoprene, and fluroelastomers.

17. The method of claim 14, wherein the woven cloth material is a glass based fabric.

18. The method of claim 13, further comprising providing a dampening layer, the dampening layer disposed between the enclosure and the protective layer.

19. The method of claim 13, further comprising providing an electrical insulation layer, the electrical insulation layer covering the battery cells and the interconnecting conductive paths, the electrical insulation layer comprising one or more sheets of fire-retardant paper/cardboard covering at least the interconnecting conductive layers, the electrical insulation layer comprising a shrink-wrap layer covering the fire-retardant paper/cardboard, the interconnecting conductive layers and the battery cells.

20. A battery pack comprising:
an enclosure;
one or more battery cells held within the enclosure;
a protective layer disposed within the enclosure and encapsulating the battery cells;
connection terminals electrically accessible from outside of the enclosure and electrically accessible from inside of the enclosure, the terminals conducting electricity through the enclosure;
two or more conductors, each conductor electrically connecting a contact of the connection terminal with a terminal of one or more of the battery cells or connecting the terminal of one or more of the battery cells with another terminal of one or more of the battery cells; and
a dampening layer, the dampening layer disposed between the protective layer and the enclosure;
whereas the protective layer contains excess heat and forces created when one or more of the battery cells overheat, vent or explode and the dampening layer reduces vibration and rattle of the battery cells within the enclosure.
